(19) United States
(12) Patent Application Publication
(10) Pub. No.: US 2019/0328039 A1
(43) Pub. Date: Oct. 31, 2019

(54) VAPORISER INSERT, VAPORISER-TANK UNIT FOR AN INHALER, INHALER, AND METHOD FOR PRODUCTION

(71) Applicant: HAUNI MASCHINENBAU GMBH, HAMBURG (DE)

(72) Inventors: NIKLAS ROMMING, HAMBURG (DE); JAN JAKLIN, FREIBURG (DE); TIM ULLNER, HAMBURG (DE); LASSE CORNILS, HAMBURG (DE); KAREN KALAYDZHYAN, HAMBURG (DE)

(21) Appl. No.: 16/366,346

(22) Filed: Mar. 27, 2019

(30) Foreign Application Priority Data
Apr. 27, 2018 (DE) 102018206647.7

(51) Int. Cl. A24F 47/00; H05B 1/02

(52) U.S. Cl. CPC A24F 47/008; H05B 2203/017; H05B 1/0297

(57) ABSTRACT

A vaporiser insert for an inhaler comprises at least one electrical vaporiser for vaporising liquid fed to the vaporiser, and electrical contacts for making electrical contact with the vaporiser insert for supplying with electrical energy and/or for receiving control signals for the vaporiser. The vaporiser insert has a base part with opposingly arranged faces and a jacket side between the faces arranged around at least one flow channel through which vapour can flow, wherein at least one liquid opening for feeding vaporisable liquid from the outside into the vaporiser insert to the vaporiser is arranged on the jacket side of the base part.

### CROSS REFERENCE TO A RELATED APPLICATION

This application claims priority under 35 U.S.C. § 119(e) of German Patent Application No. DE 10 2018 206 647.7, filed Apr. 27, 2018, which is incorporated herein by reference in its entirety.

### FIELD OF THE INVENTION

The present invention relates to a vaporiser insert for an inhaler comprising at least one electrical vaporiser for vaporising liquid fed to the vaporiser, and electrical contacts for making electrical contact with the vaporiser insert for supplying with electrical energy and/or for receiving control signals for the vaporiser. The present invention further relates to a vaporiser-tank unit for an inhaler, an inhaler, and a method for producing a vaporiser-tank unit and/or an inhaler.

### BACKGROUND OF THE INVENTION

Widely differing vaporiser units, most being based on the wick-coil principle, are used in current inhalers or electronic cigarettes according to the prior art. The vaporiser units have widely differing geometry, which among other things, is due to the widely varying shapes and sizes of the various inhalers on the market.

Furthermore, in the prior art, the vaporiser unit runs partially or completely dry and the surface of the vaporiser is insufficiently wetted. In both cases, temperatures above 250° C. occur due to the absence of cooling by the juice or liquid to be vaporised, which leads to the formation of noxious substances due to decomposition and radicalisation of the juice components, principally glycerine and propylene glycol. The quality of the resulting aerosol is affected unintentionally and in an uncontrolled manner due to an uncontrolled and unmonitored feed and vaporisation of liquid.

In addition, current systems often leak for manufacturing reasons, thus enabling liquid or juice to escape in an undesirable manner, for example via the air feed and/or the vapour discharge.

An inhaler having a liquid reservoir and a vaporiser is disclosed in DE 10 2016 114 718 A1, wherein the vaporiser is encompassed by a feed device which is arranged in a replaceable consumption unit of the inhaler. The consumption unit is a cartridge which can be replaced by the consumer and in which the feed device with the vaporiser is integrated by the manufacturer.

### BRIEF SUMMARY OF THE INVENTION

The object of the present invention is to provide standardised components for an inhaler which fulfil the requirements of different providers and which can be integrated cost-effectively and by simple assembly, and to specify appropriate production methods.

The invention achieves the object with the characteristics of the independent claims.

According to the invention, the vaporiser insert has a base part with opposingly arranged faces and a jacket side between the faces arranged around at least one flow channel through which vapour can flow. At least one liquid opening for feeding vaporisable liquid from the outside into the vaporiser insert to the vaporiser is arranged on the jacket side of the base part. The insert therefore comprises the components which are important for the vaporisation process.

Inside the vaporiser insert, the flow channel, through which the air or the aerosol flows during consumption by a consumer of an inhaler comprising the vaporiser insert, extends between the two faces. The at least one vaporiser is associated with the flow channel and is designed to heat the liquid and to add vapour and/or aerosol with flavouring and/or active ingredients to the airflow flowing through the flow channel.

The invention allows the base part to be encompassed by a liquid tank from which liquid can be fed to the at least one vaporiser for vaporising. A longitudinal axis is defined between the faces and advantageously perpendicular thereto. The base part encompasses the longitudinal axis. Advantageously, the longitudinal axis extends between the faces and/or cuts at least one of the faces at right angles. The jacket side describes the outer side of the base part extending in the longitudinal direction which encloses the longitudinal axis.

The base part is preferably in the shape of a cartridge or jacket. The cartridge shape, or advantageously jacket shape, of the vaporiser insert is space-saving and advantageously has a neutral form which extensively allows freedom in the design of an external part encompassing the vaporiser insert, and/or of an inhaler. The cartridge or jacket shape of the vaporiser insert advantageously allows a versatile option for fitting in any tank shape. The integration of the air and/or aerosol feed by means of the flow channel inside the vaporiser insert and an advantageous connection concept to different tank solutions by means of the liquid opening provide a standardised aerosol quality and, where appropriate, improved sealing of the products, for example the inhalers.

The vaporiser insert can be used in many possible products regardless of their shape, size or tank principle. The liquid tank can be closed or open, that is to say a closed and/or open tank system. Preferably, the vaporiser insert is designed as a capsule. Advantageously, the base part separates the liquid tank from the vaporiser or heater, and the base part defines a boundary surface between liquid in the liquid tank and the flow channel.

All known technologies can be called upon for the vaporiser, and the vaporiser can be designed as a micro-electromechanical or MEMS vaporiser, as a wick and/or as a coil. The vaporiser is arranged in an area of the flow channel which, due to its heating by the electrical vaporiser, is also referred to as a burner. Downstream from the burner, referred to the airflow typically occurring through the flow channel when consuming an inhaler fitted with the vaporiser insert by a consumer, the flow channel is described as a chimney.

Preferably, the vaporiser insert can be arranged in an external part, in particular in a liquid tank, in particular inserted or slid thereinto, in order to allow easy and effective assembly. The vaporiser insert is preferably an insert for arranging, inserting, for example sliding into, twisting into and/or screwing into the liquid tank of an inhaler. The external part preferably has an insertion opening, an outlet opening and/or an assembly channel formed corresponding to the external form of the vaporiser insert with an insertion opening into which the vaporiser insert can be arranged and/or slid.

Preferably, the vaporiser insert or the base part has a cross section which is constant section-by-section and narrows uniformly along the flow channel in order to facilitate assembly of the vaporiser insert. The cross section does not necessarily have to be round and can, for example, be polygonal or multisided or oval. A cross section which is not round at least in some sections enables the vaporiser insert to be assembled so that it cannot rotate.

Preferably, the vaporiser insert comprises at least one retaining and/or fixing element for retaining and/or fixing the vaporiser insert in the external part in order to prevent accidental loosening of the vaporiser insert in the external part. The vaporiser insert can also provide a counter piece for a retaining and/or fixing element in the external part. The fixing of the vaporiser insert in the external part can be releasable or non-releasable.

Preferably, the vaporiser insert can be fitted in the external part such that it cannot rotate in order to guarantee that the liquid opening is associated with a corresponding feed opening in the external part and/or the electrical contacts of the vaporiser insert can be brought into active connection with electrical contacts of a component part of the inhaler in order, for example, to establish a supply with electrical energy from an energy storage device. Preferably, the vaporiser insert comprises an anti-rotation element on the jacket side of the base part, such as a latching element, lug, slot and/or recess for example.

In a preferred embodiment, the electrical contacts are arranged on one of the faces of the vaporiser insert in order to be able to establish a simple electrical connection to an external component, for example a component part to an energy storage device.

It is of advantage that at least one permeable-to-air ventilation and/or venting device is provided in the base part for ventilating and/or venting a liquid tank in order to prevent unwanted pressure differences between the liquid tank and the flow channel. The vaporising of liquid fed from the liquid tank results in a vacuum occurring in the liquid tank or a reducing pressure gradient occurring at the vaporiser, which can lead to juice being forced away from the vaporiser and the latter thus becoming dry. A reducing gradient at the vaporiser can also occur as a result of the device being conveyed to great heights, for example when transporting in an aeroplane, wherein the reduced external pressure can lead to an uncontrolled escape of juice from the liquid tank. An unwanted vacuum can also occur by the consumer sucking at a mouthpiece of the inhaler while the vaporiser is not heated. This leads to juice escaping through the vaporiser. This can be prevented by ventilating and/or venting the liquid tank via the chimney of the vaporiser insert, as a vacuum is then present simultaneously at the liquid tank and therefore at the rear, or that is to say the, of the vaporiser facing the liquid tank. Preferably, the ventilation and/or venting is designed such that, regardless of the spatial orientation of the vaporiser insert, it is guaranteed that only air can pass through the ventilation and/or venting device and the passage of juice is prevented.

Preferably, the flow channel comprises pre and/or post-treatment areas for pre-treatment and/or post-treatment of air and/or vaporised liquid flowing through the flow channel in order to achieve an improved aerosol-vapour mixture quality. Pre-treatment preferably occurs upstream of the burner. Post-treatment preferably occurs downstream of the burner in the chimney. The aerosol-vapour mixture occurring at the vaporiser can be post-treated on the way to a mouthpiece located downstream of the vaporiser in the burner and/or in the chimney by pre and/or post-treatment devices. Air feeds, for example, are therefore conceivable in order to guarantee mixing with secondary air and/or to avoid contact due to laminar flows with the chimney wall or flow channel wall and therefore possible condensation. It is also conceivable for the pre and/or post-treatment devices to be designed to affect the incident flow of the airflow towards the vaporiser. The pre and/or post-treatment areas can have air guiding elements, for example, for this purpose. The air feed is designed to add preferably cooler fresh air to the airflow in the flow channel. Pre-heated air is also conceivable, i.e. the airflow is heated before impinging on the vaporiser. Possible post-treatment comprises post-heating of the airflow after passing the vaporiser.

In a preferred embodiment, the vaporiser insert comprises a plurality of electrical vaporisers in order to be able to match the vaporiser performance to the requirements and characteristics of the particular juice.

Preferably, the electrical vaporisers are arranged along the periphery of the jacket side of the base part and/or along the flow channel in order to enable uniform and effective vaporisation within the flow channel.

Preferably, the vaporiser insert has a plurality of liquid openings, wherein liquid from a corresponding liquid opening can be fed to each electrical vaporiser in order to guarantee the transportation of liquid to each vaporiser. Preferably, liquids from different liquid tanks or chambers of a liquid tank can be fed to different vaporisers to enable a mixing and/or choice of flavourings and/or active ingredients.

Preferably, the vaporiser insert has at least one retaining element on the jacket side of the base part, for example a spur for securing a capillary element, in order to be able to supply the liquid opening with liquid regardless of the orientation of the vaporiser insert. The capillary element, for example a sponge, is designed to store liquid and feed it to the juice feed element. By this means, sufficient juice can be provided even when an inhaler is used for a short time with the vaporiser insert upside down to enable consumption of the inhaler.

Preferably, the vaporiser insert comprises at least one secondary air channel which is separate from the flow channel in order to be able to feed fresh air and/or to be able to guarantee pressure measurements independently from the vaporisation or aerosol formation. Preferably, the vaporiser insert comprises a separation wall and the separation wall is designed to separate the flow channel from the secondary air channel. The secondary air channel is advantageously a bypass to the flow channel, which can also be referred to as the main air channel. Preferably, the cross section of the secondary air channel is less than the cross section of the main air channel at least in some sections.

In a preferred embodiment, the liquid opening communicates with a juice feed element, wherein the juice feed element is designed to transport liquid to the vaporiser to enable a leak-free and controlled feed of liquid or juice. The juice feed element, for example a wick, is preferably a capillary element which is designed to feed the liquid to the vaporiser by means of capillary forces. For example, the juice feed element can be a porous medium, wick or similar. The juice feed element can preferably be retained in or by the base part. The vaporiser insert is therefore preferably a capsule and preferably comprises both the heater and the wick or, that is to say, part of the wick system.

Preferably, the vaporiser insert comprises an electronic unit for controlling and/or regulating the vaporiser and/or for storing characteristic data in order, for example, to be able to link the control and/or regulation with the identification of the vaporiser insert. Any type of identification is possible, for example passive electronic methods such as resistor networks.

A vaporiser-tank unit according to the invention comprises a liquid tank and a vaporiser insert inserted in the liquid tank. The liquid tank has an insertion opening and an outlet opening, wherein the vaporiser insert extends from the insertion opening to the outlet opening. This enables assembly or sliding of the vaporiser insert into the insertion opening and the outlet opening in a functional manner. The vaporiser insert can, for example, emerge from the liquid tank from the outlet opening, be flush with the liquid tank, or terminate inside the liquid tank at the outlet opening.

Preferably, the vaporiser insert can be fed into the liquid tank such that the liquid tank encompasses the jacket side of the vaporiser insert at least in the section with the liquid opening. This ensures that the liquid can be transported from the liquid tank through feed openings provided in the liquid tank and the liquid openings of the vaporiser insert for vaporisation.

In a preferred embodiment, a capillary element inside the liquid tank is associated with the liquid opening in order, for example, to store liquid regardless of orientation, to guarantee an orientation-independent transport of liquid from the liquid tank to the liquid opening, and/or to prevent an uncontrolled escape of juice.

Preferably, the vaporiser insert is retained in the vaporiser-tank unit so that it cannot rotate, in order, for example, to enable an unambiguous association of the feed opening and the liquid openings provided in the liquid tank and/or the contacts and corresponding contacts of a further external component part or component of the inhaler. In this embodiment, the vaporiser insert preferably has an anti-rotation element. The vaporiser insert can also provide a counter piece to an anti-rotation element in the external part. The anti-rotation device can also be formed by a non-rotationally symmetrical or out-of-round cross section of the base part.

Preferably, the liquid tank comprises a plurality of chambers which are separate from one another, wherein liquid from a corresponding chamber can be fed to each electrical vaporiser to enable the transportation to the vaporiser of preferably different liquids stored in the chambers.

Optionally, the liquid tank can have at least one air-permeable ventilation and/or venting element to prevent the formation of a vacuum in the liquid tank and to guarantee a pressure balance and a reliable conveying of liquid.

Advantageously, at least one of the faces of the vaporiser insert is flush with a corresponding face of the liquid tank in order to be able to provide a geometrically closed vaporiser-tank unit.

The vaporiser insert is inserted, in particular slid, into the insertion opening and as far as the outlet opening of the liquid tank in order to enable simple assembly of the vaporiser insert and the liquid tank.

Preferably, the vaporiser insert is fed, in particular slid, with the outlet-side face as far as the outlet opening, the liquid tank is then filled with liquid via a filling opening arranged or remaining between the base part and the insertion opening, and the vaporiser insert is then fed, in particular slid, through the insertion opening as far as a stop, at the same time closing the filling opening. The stop can be formed, for example, by a collar on the inlet-side face of the vaporiser insert, the shape of the base part, of the insertion opening and/or of the outlet opening. In a preferred embodiment, the stop can be formed by the base plate of the vaporiser insert, for example when this projects above the base part in the form of a collar. A conical design of the collar is also possible. Advantageously, sealing elements can be associated with the insertion opening and/or outlet opening in order to be able to provide a leak-free vaporiser-tank unit.

### BRIEF DESCRIPTION OF THE FIGURES

The invention is explained below based on preferred embodiments with reference to the attached figures. In the drawings

FIG. 1 shows a longitudinal section through a vaporiser insert;

FIG. 2 shows a longitudinal section through a vaporiser-tank unit;

FIG. 3 shows a longitudinal section through a vaporiser-tank unit having a vaporiser insert with a spur;

FIGS. 4, 5 show a longitudinal and a cross section through a vaporiser-tank unit having a dual-chamber liquid tank and a vaporiser insert with two vaporisers;

FIGS. 6, 7 show a perspective view and a longitudinal section of a vaporiser-tank unit with an angular cross section;

FIG. 8A, 8B shows a perspective view and a longitudinal section of a vaporiser-tank unit with a round cross section;

FIGS. 9-11 show perspective views of a vaporiser-tank unit with a mouthpiece;

FIG. 12 shows a schematic diagram of an inhaler;

FIG. 13 shows a schematic diagram of a vaporiser having a juice feed element and a liquid tank;

FIG. 14 shows a longitudinal section through a vaporiser insert having a secondary air channel; and

FIGS. 15 shows a longitudinal section through a vaporiser-tank unit in an advantageous embodiment.

### DETAILED DISCLOSURE

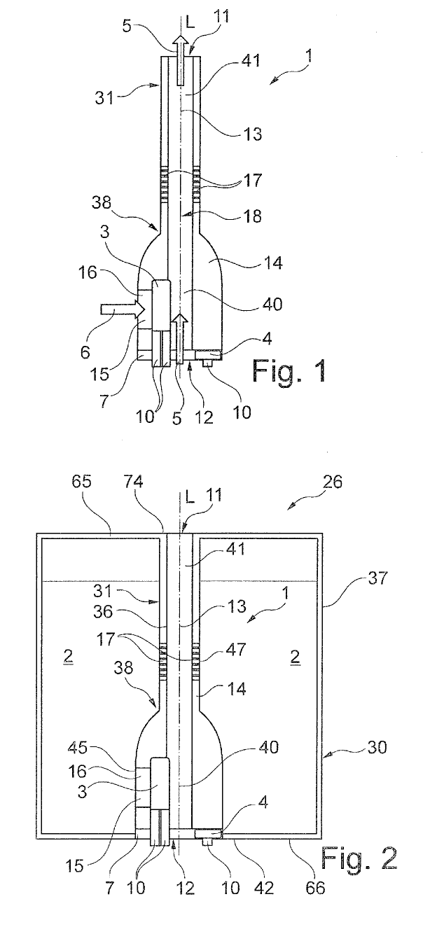

FIG. 1 shows a vaporiser insert 1 for an inhaler 27 comprising an electrical vaporiser 3 for vaporising liquid 2 fed from the vaporiser 3. The vaporiser insert 1 has opposing faces 11, 12 and a base part 14 between the faces 11, 12 arranged around a flow channel 13 through which vapour can flow. A longitudinal axis L is defined along the flow channel 13 and/or between the faces 11, 12. The base part 14 can preferably extend along the longitudinal axis L or the flow channel 13 between the faces 11, 12.

The vaporiser insert 1 is cartridge or sleeve-shaped. In this example, the base part 14 has a round cross section section-by-section and the longitudinal extension along the flow channel 13 is greater than the diameter of the base part 14. The vaporiser insert 1 is therefore elongated. Preferably, the vaporiser insert 1 has a length of 0.1 cm to 10 cm, further preferably 0.5 cm to 5 cm, for example of 2 cm, and a diameter of preferably 0.1 cm to 1 cm, further preferably 0.25 cm to 0.75 cm, for example 0.5 cm. Along the longitudinal axis L of the vaporiser insert 1, the base part 14 has a hollow-cylinder-shaped section 41 and a section 40, which is not necessarily tapering, with a diameter or cross section which reduces in the downstream direction.

When inhaling or consuming, a consumer draws on a mouthpiece 39 of the inhaler 27, wherein a suction pressure occurs which causes an airflow 5 through the flow channel 13. The air enters the flow channel 13 at a face 12 facing away from the mouthpiece 39, flows through the flow channel 13, and exits from the flow channel 13 at a face 11 facing the mouthpiece 39. In the flow channel 13, vaporised liquid 2 is added to the airflow in order to deliver an aerosol or aerosol-vapour mixture to the consumer.

The air channel 13 comprises a section designated as burner 40 which is associated with the vaporiser 3, and a chimney 41 arranged downstream of the vaporiser 3. The chimney 41 can be supported accordingly or be shortened by the user and/or manufacturer depending on the required length.

At least one liquid opening 15 for feeding vaporisable liquid 2 radially from the outside into the vaporiser insert 1 to the vaporiser 3 is arranged in the base part 14. A juice feed element 16 is associated with the liquid opening 15. The juice feed element 16 serves to feed the liquid 2 through the liquid opening 15 to the vaporiser 3, see, for example, FIG. 13 and the associated description.

The vaporiser insert 1 comprises electrical contacts 10 for electrically connecting the vaporiser insert 1 for the external supply with electrical energy and/or for receiving control signals for the vaporiser 3. In this exemplary embodiment, the contacts 10 are arranged on a base plate 7 of the vaporiser insert 1 arranged upstream of the vaporiser 3. The contacts 10 can make an electrical connection between the vaporiser 3 and a component part of the inhaler 27, which includes an energy storage device 55, for example for heating the vaporiser 3. The contacts 10 can, for example, make an electrical connection between an electronic unit 4 of the vaporiser insert 1 and an electronic control device 56 provided in the inhaler 27 in order to be able to exchange data, for example identifications, filling levels, operating times etc.

The preferably standardised electrical contact between the vaporiser insert 1 and/or a vaporiser-tank unit 26 or a cartridge and/or a component part of the inhaler 27 serves, for example, to energise the vaporiser or vaporisers 3 and/or an identification of the cartridge by means of an ID chip or other identification method provided in the electronic unit 4. The electronic unit 4 can be connected via a serial interface, for example via a single-wire bus, to the component part, and/or use common contacts 10 with the vaporiser 3. Preferably, the contacts 10 are defined in an anti-rotation standard arrangement, for example in the form of concentric contact pads for spring-loaded pins. However, a contactless identification method, for example via RFID and/or near field communication (NFC), is also conceivable.

The vaporiser insert 1 is preferably made from a plastic, and/or the base plate 7 comprises a printed circuit board (PCB). The base plate 7 can be removably or permanently connected to the base part 14. The base plate 7, the burner 40 and the chimney 41 preferably define a standardised constructional unit which is suitable for differently shaped liquid tanks 30. Embodiments without base plate 7 are also conceivable.

At least one pre and/or post-treatment area 18 with a pre and/or post-treatment device (not shown) can be provided in the flow channel 13. An obstructive element or sponge, for example, which prevents a direct escape of large droplets or juice, can be provided as standard in the pre and/or post-treatment area 18. An air guidance and/or resistance element can be provided in selected and suitable areas of the overall flow channel 13. Further, a heating and/or cooling element can be used as pre and/or post-treatment device for post-treating the aerosol.

The airflow 5 can be affected and the flow of incident air to the vaporiser 3 defined by appropriately shaped hollows on the inside of the base part 14 or, that is to say, in the air channel 13. The hollows can be associated with the pre and/or post-treatment areas 18. In this way, for example, a laminar transverse flow of the air over the surface of the vaporiser 3, a perpendicular flow, and/or a tangential transverse flow can be achieved. The airflow 5 when impinging on the vaporiser 3 and the aerosol quality, such as for example the mixing and/or droplet size, can be affected by the opening cross section of the air feed.

FIG. 2 shows a vaporiser-tank unit 26 according to the invention comprising a vaporiser insert 1 and a liquid tank 30. The liquid tank 30 has a housing 37 and, for example, an assembly channel 35 indicated in FIGS. 7 to 11 and encompasses said channel in the circumferential direction. The optional assembly channel 35 can be actively connected to an insertion opening 42 and an outlet opening 74, in which a vaporiser insert 1 can be arranged, in particular slid or inserted. The assembly channel 35 is preferably defined by an inner surface 36 of the liquid tank 30 or of the housing 37. The base part 14 has a jacket side 31, wherein the inner surface 36 is matched to the jacket side 31. Preferably, the jacket side 31 of the base part 14 contacts the inner surface of the assembly channel in an interlocking manner in order to enable space-saving and leak-free assembly. Advantageously, the vaporiser insert 1 can be inserted or slid into the assembly channel 35 along the longitudinal axis L.

In other embodiments, the assembly channel 35 is defined by fitting the vaporiser insert 1 into the liquid tank 30, wherein the jacket side 31 locks the liquid tank 30 in the vaporiser-tank unit 1 and guarantees freedom from leaks.

The inner surface 36 of the assembly channel 35 has a feed opening 45 corresponding with the liquid opening 15 of a vaporiser insert 1 slid into the assembly channel 35. When assembling the vaporiser-tank unit 26, the feed opening 45 is aligned with the liquid opening 15 to enable liquid 2 to be fed out of the liquid tank 30 to the vaporiser 3.

At least one ventilation and/or venting device 17 can be provided in the flow channel 13, for example in the chimney 41. The ventilation and/or venting device 17 can have a plurality of perforations, for example along the chimney 41. In order to prevent an escape of juice through the holes or perforations, the chimney 41 or the base part 14 can be designed by a suitable choice of material, the utilisation of the Lotus effect or a structuring of the surface, for example nanostructuring, such that the contact angle between the surface and the juice is as large as possible and the surface becomes liquid-repellent. In addition, juice entering the chimney 41 can be collected by a capillary element 33 and leakage thereby prevented.

Preferably, the liquid tank 30 has at least one air-permeable ventilation and/or venting element 47. In the assembled vaporiser-tank unit 26, the ventilation and/or venting element 47 is preferably aligned with the ventilation and/or venting devices 17 in order to functionally interact. The base part 14 can also be made of a semipermeable material which allows no liquid 2 to enter the flow channel 13 and at the same time allows ventilation and/or venting of the liquid tank 30.

The vaporiser insert 1 preferably has a retaining and/or fixing element 38 for fixing and retaining the vaporiser insert 1 in the insertion opening 42, the outlet opening 74 and/or the assembly channel 35 or, that is to say, in the liquid tank 30. The retaining and/or fixing element 38 can, for example, have a recess, bulge, lug, slot and/or a latching element. The retaining and/or fixing element 38 can be single-sided and/or non-rotationally symmetrical to enable an assembly of the vaporiser insert 1 in the liquid tank 30 so that it cannot rotate. The retaining and/or fixing element 38 effects a stationary retention of the vaporiser insert 1 in the liquid tank 30 and prevents sliding and/or rotation of the vaporiser insert 1. As shown in the exemplary embodiment, the retaining and/or fixing element 38 can be formed by the shape of the jacket side 31 of the jacket housing 14. The retaining and/or fixing element 38 shown comprises a tapering of the base part 14 and prevents sliding in the direction of the longitudinal axis L of the vaporiser insert 1.

The retaining and/or fixing element 38 can retain the vaporiser insert 1 irremovably in the liquid tank 30, for example by welding, so that the vaporiser-tank unit 26 is a product in which the vaporiser insert 1 is permanently and, for the consumer, irremovably fitted. Alternatively, use in open tank systems which have a liquid reservoir 30 which can be refilled by the user is conceivable.

The retaining and/or fixing element 38 can be designed such that the vaporiser insert 1 can be inserted into and removed from the insertion opening 42, the outlet opening 74 and/or the assembly channel 35, or, that is to say, the liquid tank 30. This allows a reversible assembly of the vaporiser-tank unit 26 and replacement of the vaporiser insert 1 while retaining the liquid tank 30, wherein the liquid tank 30 and/or the vaporiser insert 1 can be designed as a reusable part. Integration of the vaporiser insert 1 in different liquid tanks 30 with different tank systems is conceivable with the embodiments explained.

The basic form of the cartridge-shaped vaporiser insert 1 is designed to enable the vaporiser insert 1 to be fitted in different liquid tanks 30 with only minimal adaptation and preferably few mechanical interfaces. Advantageously, the vaporiser insert 1 is connected to the liquid tank 30 to form a seal in order to avoid a leakage of liquid at the connecting point. The connection between the vaporiser insert 1 and the liquid tank 30 can be realised, for example, by a press fit, welding and/or gluing.

As a result of integrating the vaporiser function and the electronic control in the vaporiser insert 1, the functional demands on the liquid tank 30 are low and are limited to accommodating the juice or liquid 2. This leaves the form of the liquid tank 30 or the housing 37 open, as, preferably, the sole limitation on the housing form 37 is the recess for the insert opening 42, the outlet opening 74 and/or the insertion channel 35.

An embodiment is also conceivable in which a plurality of vaporiser inserts 1 can be inserted, e.g. serially in the longitudinal direction, for example in the assembly channel 35, and/or in a plurality of assembly channels. That is to say, in the embodiments, the vaporiser inserts 1 can be inserted serially in line or parallel/adjacent to one another. For example, a common airflow 5 is guided serially through a plurality of vaporiser inserts 1. A plurality of vaporiser inserts 1 can also be inserted in a plurality of liquid tanks 30 and/or a plurality of chambers of a liquid tank 30 in order to achieve a combination of flavourings and/or active ingredients.

The inlet-side face 12 of the vaporiser insert 1, as the case may be the base plate 7, is advantageously flush with an inlet-side face 65 of the housing 37. The outlet-side face 11 of the vaporiser insert 1 is advantageously flush with an outlet-side face 66 of the housing 37. As a result, a compact design of the vaporiser-tank unit 26 is achieved.

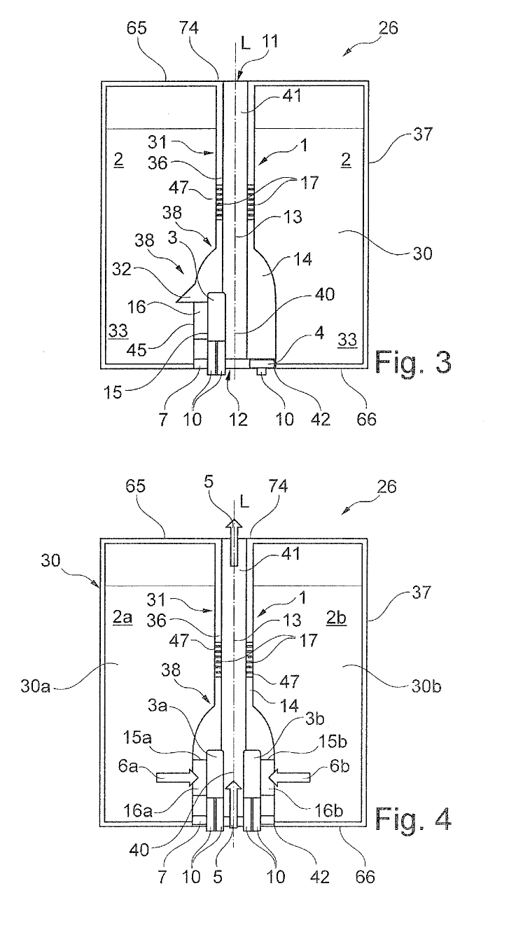

FIG. 3 shows a vaporiser-tank unit 26 having a vaporiser insert 1 with a spur 32 provided on the jacket side 31 of the base part 14 which can be provided to retain a capillary element 33 inside a liquid tank 30.

The spur 32 can serve as a retaining and/or fixing element 38 and guarantee an assembly of the vaporiser insert 1 in the liquid tank 30 which cannot slide and/or rotate. The spur 32 can also be formed around the whole circumference as a collar on the jacket side 31 of the base part 14. The spur 32, that is to say the lip, is advantageously narrower than the section of the base part with the greatest circumference, that is to say than that of the collar associated with the base plate 7, in order to enable assembly of the vaporiser insert 1 by sliding into the liquid tank 30.

The capillary element 33 is designed to store liquid 2 and to feed it to the juice feed element 16. The use of a capillary element 33 or a porous medium enables storage and/or buffering of liquid 2 at a place defined by the capillary element 33 regardless of the orientation and/or the filling level of the liquid tank 30 or the cartridge. The capillary element 33 extends at least section-by-section and/or completely within the liquid tank 30.

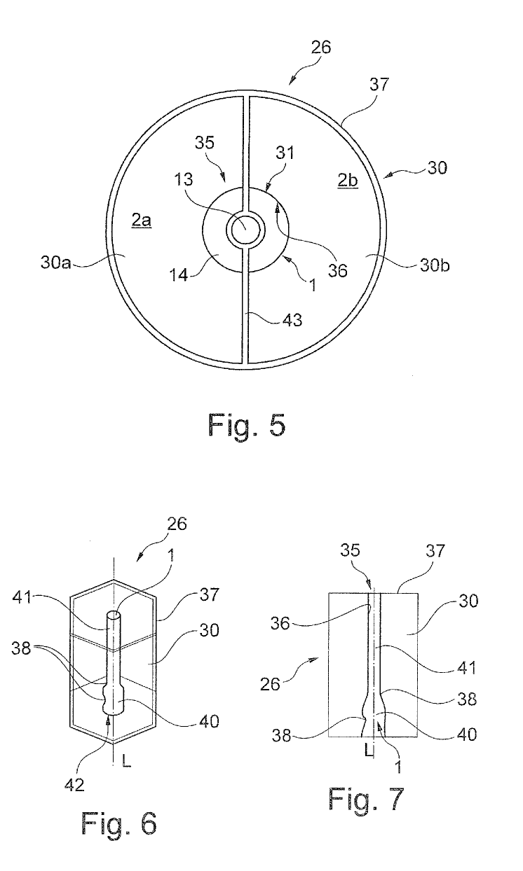

FIGS. 4 and 5 show a vaporiser-tank unit 26 having a plurality, here for example two, chambers 30a, 30b in a liquid tank 30 and a vaporiser insert 1 with here two vaporisers 3a, 3b, two liquid openings 15a, 15b, two juice feed elements 16a, 16b and two liquid flows 6a, 6b, which feed two preferably different liquids 2a, 2b from the chambers 30a, 30b to the vaporisers 3a, 3b for vaporisation. In this example, the liquid tank 30 is segmented by a separating wall 43 and is designed to store different liquids 2a, 2b. Using a plurality of chambers 30a, 30b enables any tank geometry to be used in which the separating walls 43 are provided for separating the liquids 2a, 2b.

Preferably, a plurality of juice feed elements 16a, 16b are arranged on the base part 14 offset in the circumferential direction of the base part 14 and communicate with the liquid opening 15 or plurality of liquid openings 15a, 15b. The juice feed elements 16a, 16b can be arranged at equal distances or at equal angular distances in the circumferential direction in order to allow a uniform feed of liquid from the liquid tank 30 and/or the chambers 30a, 30b. In an embodiment the juice feed elements 16a, 16b can be arranged along the flow channel 13. The liquid tank 30 can be in one piece and include the chambers 30a, 30b separated by the separating wall 43. The liquid tank 30 can be in several parts, and separate chambers 30a, 30b can be placed independently of one another in the vaporiser-tank unit 26.

FIG. 4 shows a longitudinal section and FIG. 5 a cross section through a radial plane of the vaporiser-tank unit 26. The section shows that the base part 14 is preferably arranged radially inside the housing 37 of the liquid tank 30, that is to say the chambers 30a, 30b respectively.

Depending on the design, any number or a plurality of vaporisers 3a, 3b, which by means of their respective juice feed element 16a, 16b can vaporise one or more liquids 2a, 2b from one or more chambers 30a, 30b, can be provided in the vaporiser insert 1. A standardised vaporiser assembly having the vaporisers 3a, 3b including supporting material can preferably be fitted in a vaporiser insert 1 which is designed for use with a liquid 2 or with a plurality of liquids 2a, 2b.

FIGS. 6 and 7 show a vaporiser-tank unit 26 having an angular, for example hexagonal, cross section and a vaporiser insert 1 inserted in the assembly channel 35. The external form of the liquid tank 30 or the housing 37 is independent of the form of the vaporiser insert 1.

For assembly, the vaporiser insert 1 is fed into an insertion opening 42 formed by the housing 37 of the liquid tank 30 into the assembly channel 35. The vaporiser insert 1 is securely held in its operating position in the assembly channel 35 so that it cannot rotate or slide. A reliable liquid feed from the liquid reservoir 30 and electrical contact with a component part of the inhaler 27 can be ensured by retaining the vaporiser insert 1 in the assembly channel 35 so that it cannot rotate or slide.

In this exemplary embodiment, the vaporiser insert 1 has a plurality, here two, of retaining and/or fixing elements 38. One retaining and/or fixing element 38 is arranged in the area of the burner 40 and is designed as a recess in the base part 14. The recess can also be provided in other positions on the jacket side 31 of the base part 14 as long as the inner surface 36 of the assembly channel 35 has a corresponding bulge in order to allow an interlocking connection between liquid tank 30 and vaporiser insert 1. The base part 14 has a round cross section section-by-section which tapers downstream between burner 40 and a chimney 41. Advantageously, the base part 14 tapers continuously starting from the base plate 7. The tapering of the jacket side 31 of the base part 14 effects a stop which prevents arbitrary sliding along the longitudinal axis L of the vaporiser insert 1 or, that is to say, along the assembly channel 35. The tapering can therefore be considered to be a retaining and/or fixing element 38. In the embodiment shown, the vaporiser insert 1 has an annular widening at the end associated with the base plate 7.

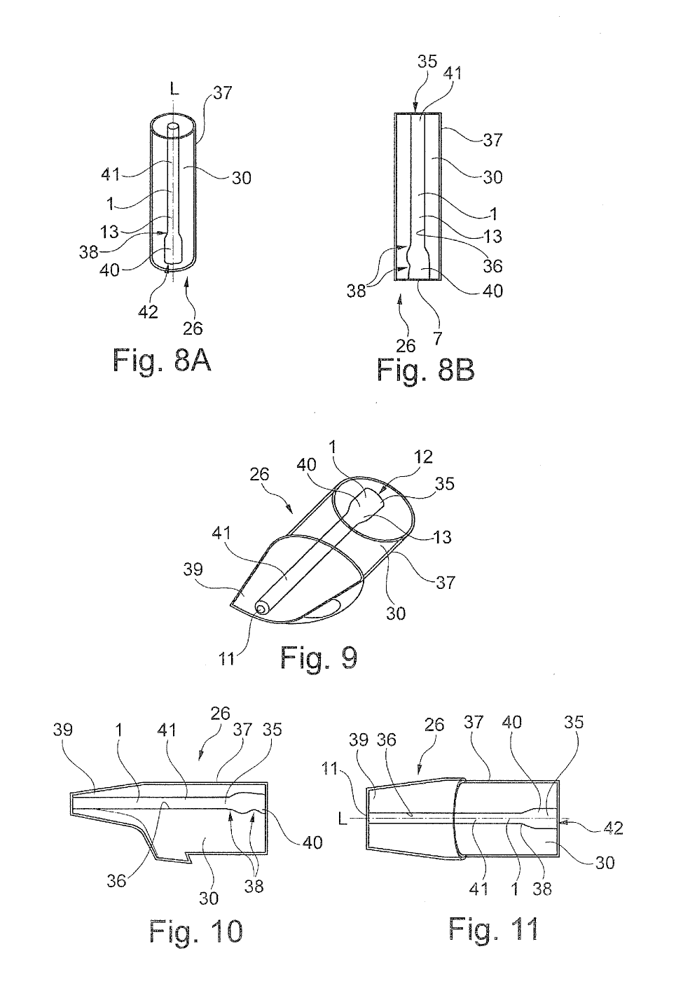

FIG. 8 shows a vaporiser-tank unit 26 having a round cross section and illustrates different possible and non-exhaustive forms of the liquid reservoir 30 with the same connection and assembly of the vaporiser insert 1.

FIGS. 9 to 11 show a vaporiser-tank unit 26 having a mouthpiece 39 at which a consumer can draw in order to inhale. In this exemplary embodiment, the chimney 41 or the base part 14 and the air channel 13 extends as far as the mouthpiece 39. The face 11 associated with the mouthpiece 39 is flush with the mouthpiece 39.

In the embodiment shown, the base part 14 fully encompasses the air channel 13. In other embodiments which are not shown, the air channel can be formed, at least in some sections, by the housing of the liquid tank 30 or the inner surface 36 of the assembly channel 35 and/or an extension of the inner surface 36.

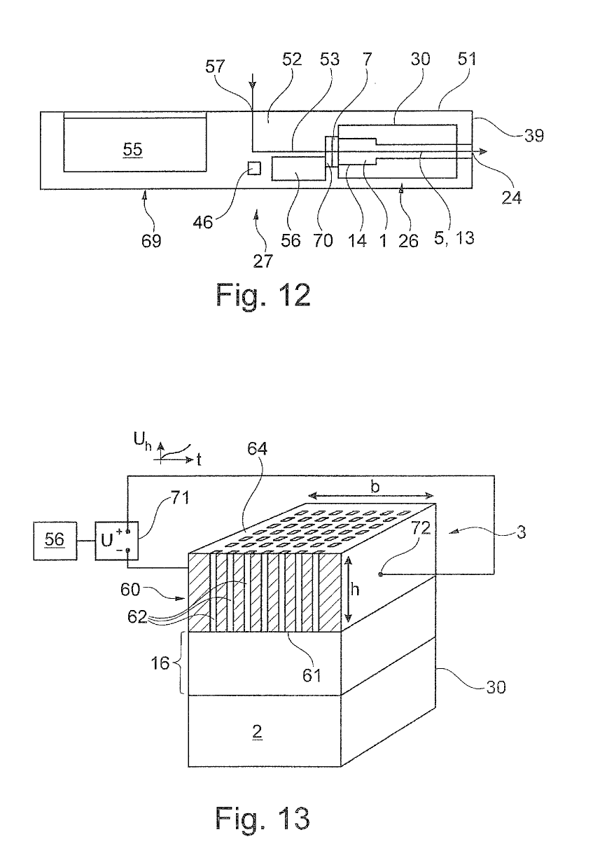

FIG. 12 shows a schematic diagram of an inhaler 27. The inhaler 27, here an electronic cigarette product, comprises an inhaler housing 51 in which an air channel 52 is provided between at least one air inlet opening 57 and an air outlet opening 24 at a mouthpiece 39 of the cigarette product 27. Here, the mouthpiece 39 of the cigarette product 27 designates the end at which the consumer draws for the purpose of inhaling and, as a result, subjects the cigarette product 27 to a vacuum and induces an airflow 53 in the air channel 52. The airflow 53 gives rise to an airflow 5 through the flow channel 13 of the vaporiser insert 1.

Advantageously, the cigarette product 27 consists of a base part 69 and a consumption unit 26 with a liquid tank 30 and a vaporiser insert 1. The consumption unit can, in particular, be designed in the form of a replaceable cartridge or in the form of a liquid tank 30 in which the consumer can place the vaporiser insert 1.

The air sucked in through the air inlet opening 57 is guided to the vaporiser insert 1 in the air channel 52. The vaporiser insert 1 is or can be connected to at least one liquid tank 30 in which at least one liquid 2 is stored. The vaporiser insert 1 vaporises liquid 2 which is fed thereto from the liquid tank 30 and adds the vaporised liquid 2 as an aerosol/vapour to the airflow 53 at an outlet side at a face 11 of the vaporiser insert 1. An advantageous volume of the liquid tank 30 lies in the range between 0.1 ml and 5 ml, preferably between 0.5 ml and 3 ml, further preferably between 0.7 ml and 2 ml or 1.5 ml.

The draw resistance can be defined by the air inlet opening 57 or an air feed, for example at the face 12 of the vaporiser insert 1 facing the air inlet opening 57. Preferably, the air feed is provided at the face 12 or in an opening of a base plate 7 of the vaporiser insert 1. The draw resistance can further be affected by appropriately formed holes or air entry openings and mouldings in the flow channel 13 of the vaporiser insert 1. However, it is also conceivable to integrate a nozzle or a defined perforated plate as an additional part.

Furthermore, the electronic cigarette 27 comprises an electrical energy store 55 and an electronic control device 56. As a rule, the energy store 55 is arranged in the base part 69 and, in particular, can be an electrochemical disposable battery or a rechargeable electrochemical battery, for example a lithium-ion battery. The electronic control device 56 comprises at least one digital data processing device, in particular microprocessor and/or microcontroller, in the base part 69 and/or in the consumption unit 26. The base part 69 expediently comprises an electronic interface 70 which is designed and arranged to make contact with the electrical contacts 10 when the vaporiser-tank unit 26 is inserted. Advantageously therefore, the electronic control device 56 and the vaporiser insert 7 are or can be connected to one another via the electronic interface 70 by means of the electrical contacts 10 of the consumption unit shown by way of example in FIGS. 1 to 4.

Advantageously, a sensor, for example a vacuum sensor 46 or a pressure or flow switch, is arranged in the inhaler housing 51, wherein the control device 56 can establish, based on a sensor signal output by the vacuum sensor 46, that a consumer is drawing on the mouthpiece 29 of the cigarette product 27 in order to inhale. In this case, the electronic unit 4 shown in FIGS. 1 to 4 is designed to energise the vaporiser 3 when the vacuum sensor 46 measures a vacuum caused by drawing. For example, the vacuum sensor 46 can feed a signal to the control device 56 to enable activation of the vaporiser insert 1 by a drawing action. For example, the control device 56 energises the vaporiser insert 1 in order to add liquid 2 from the liquid tank 30 to the airflow 53 as an aerosol/vapour.

The liquid 2 stored in the liquid tank 30 and to be dosed is, for example, a mixture of 1,2 propylene glycol, glycerine, water, at least one flavour and/or at least one active ingredient, especially nicotine. Other active ingredients and liquid mixtures, for example for medicinal applications, are not excluded.

The consumption unit or cartridge advantageously comprises a non-volatile data memory for storing information or parameters relating to the consumption unit or cartridge. The data memory can be part of the electronic control device 56. Advantageously information is stored in the data memory relating to the composition of the liquid stored in the liquid tank 30, information relating to the process profile, in particular power/temperature control; data relating to the state monitoring or system test, for example leakage monitoring; data relating to copy protection and falsification protection, an ID for uniquely identifying the consumption unit or cartridge, serial number, manufacturing date and/or expiry date, and/or number of draws (number of inhalations by the consumer) or the usage time. Advantageously, the data memory is or can be connected via contacts and/or conductors to the control device 56 and/or the electronic unit 4.

The vaporiser insert 1 preferably comprises the air feed, the air guide, the vapour discharge with possible re-condensation treatment, a ventilation and/or venting device 17, pre and/or post-treatment areas 18, a unique electronic identification, and/or electrical contacts 10 as standard so that all important functions of a cartridge for the inhaler 27, which can be integrated into liquid tanks 30 that are as versatile in form as possible, are fulfilled.

FIG. 13 shows a schematic diagram of an advantageous exemplary embodiment of a vaporiser 3. Other forms of vaporiser, for example foil vaporisers, are also possible. A foil vaporiser can at least partially form the base part 14 for example.

The exemplary vaporiser 3 according to FIG. 13 comprises a block-shaped, preferably monolithic heating core 60 made from an electrically conducting material, preferably silicon, doped ceramic, metal-ceramic, filter-ceramic, semiconductor, in particular germanium, graphite, semi-metal and/or metal. It is not necessary for the whole heating core 60 to consist of an electrically conducting material. For example, it can be sufficient for the surface of the heating core 60 to be electrically conductively coated, for example metal coated. In this case, the whole surface does not have to be coated, for example conductive tracks on a non-conducting base body can be provided. The heating core 60 can also have a perforated structure produced by laser machining for example.

The heating core 60 is provided with a plurality of micro-channels 62 which connect an inlet side 61 of the heating core 60 to an outlet side 64 in a liquid-conducting manner. The inlet side 61 is connected via a wick structure or a juice feed element 16 to the liquid tank 30 in a liquid-conducting manner. The juice feed element 16 serves to passively convey liquid 2 from a liquid tank 30 to the heating core 60 by means of capillary forces in order to provide an adequate supply of liquid for reliable aerosol production by the vaporiser or vaporisers 3 at all times. In the contact area or inlet side 61 of the heating core 60, the juice feed element 16 serves to distribute liquid 2 uniformly, to be temperature-resistant and, with its relatively small pores and/or thin capillaries, to form a kind of non-return valve in order to prevent undesirable back flow of aerated liquid 2 from the heating core 60 into the juice feed element 16 and/or into the liquid tank 30.

The mean diameter of the micro-channels 62 preferably lies in the range between 5 μm and 200 μm, further preferably in the range between 30 μm and 150 μm, even further preferably in the range between 50 μm and 100 μm. Based on these dimensions, advantageously a capillary action is generated so that, at the inlet side 61, fluid entering a micro-channel 62 rises upwards through the microchannel 62 and as far as the outlet side 64 until the micro-channel 62 is filled with liquid. The volume ratio of micro-channels 62 to heating core 60, which can be described as the porosity of the heating core 60, lies for example in the range between 10% and 50%, advantageously in the range between 15% and 40%, even further advantageously in the region between 20% and 30%, and amounts for example to 25%.

The edge lengths of the surfaces of the heating core 60 provided with micro-channels 62 lie, for example, in the range between 0.5 mm and 3 mm, preferably between 0.5 mm and 1 mm. The dimensions of the surfaces of the heating core 60 provided with micro-channels 62 can, for example, amount to 0.95 mm×1.75 mm or 1.9 mm×1.75 mm or 1.9 mm×0.75 mm. The channel lengths of the heating core 60 can, for example, lie in the range between 0.5 mm and 5 mm, preferably in the range between 0.75 mm and 4 mm, further preferably in the range between 1 mm and 3 mm. The surface of the heating core 60 (chip size) can amount, for example, to 1 mm×3 mm, 2 mm×2 mm or 2 mm×3 mm.

The width b of the heating core 60 (see FIG. 13) preferably lies in the range between 1 mm and 5 mm, further preferably in the range between 2 mm and 4 mm, and amounts, for example, to 3 mm. The height h of the heating core 60 (see FIG. 13) preferably lies in the range between 0.05 mm and 1 mm, further preferably in the range between 0.1 mm and 0.75 mm, even further preferably in the range between 0.2 mm and 0.5 mm and amounts, for example, to 0.3 mm.

The number of micro-channels 62 preferably lies in the range between four and 1000. In this way, the heat introduced into the micro-channels 62 can be optimised, and an assured high vaporisation performance and an adequately large vapour outlet surface can be realised.

The micro-channels 62 are arranged in the form of a square, rectangular, polygonal, round, oval or otherwise shaped array. The array can be designed in the form of a matrix with s columns and z rows, wherein s advantageously lies in the range between 2 and 50 and further advantageously in the range between 3 and 30 and/or z advantageously lies in the range between 2 and 50 and further advantageously in the range between 3 and 30. In this way an effective and easily produced arrangement of micro-channels 62 with assuredly high vaporisation performance can be realised.

The cross section of the micro-channels 62 can be square, rectangular, polygonal, round, oval or otherwise shaped, and/or vary section-by-section in the longitudinal direction, in particular enlarge, reduce or remain constant. The micro-channels 62 can also have bionic structures with a particularly large surface area.

The length of one or each micro-channel 62 preferably lies in the range between 100 μm and 1000 μm, further preferably in the range between 150 μm and 750 μm, even further preferably in the range between 180 μm and 500 μm, and amounts, for example, to 300 μm. In this way an optimal liquid absorption and portion formation with sufficiently good heat introduction from the heating core 60 into the micro-channels 62 can be realised.

The distance between two micro-channels 62 preferably amounts to at least 1.3 times the clear diameter of a micro-channel 62, the distance being referred to the central axis of the two micro-channels 62. The distance can preferably amount to 1.5 to 5 times, further preferably 2 to 4 times the clear diameter of a micro-channel 62. In this way, an optimal heat transfer into the micro-channels and a sufficiently stable arrangement and wall thickness of the micro-channels can be realised.

The vaporiser insert 1 preferably has a heating voltage source 71 which can be controlled by the control device 56 and which is connected to the heating core 60 by means of electrodes 72 on opposite sides thereof so that an electrical voltage Uh generated by the heating voltage source 71 leads to a flow of current through the heating core 60. As a result of the ohmic resistance of the electrically conducting heating core 60, the current flow leads to a heating of the heating core 60 (Joule heating) and hence to a vaporisation of liquid contained in the micro-channels 62. The heating core 60 therefore works as a vaporiser. In this way, generated vapour/aerosol escapes to the outlet side 64 from the micro-channel 62 and is mixed with the airflow 5 in the flow channel 13, see FIG. 1. More accurately, on establishing an airflow 5 through the flow channel 13 caused by a drawing action by the consumer, the control device 56 energises the heating voltage source 71, wherein the liquid in the micro-channels 62 is driven out of the micro-channels 62 in the form of vapour/aerosol due to spontaneous heating.

In doing so, the duration of the individual vaporisation steps at different temperatures and/or vaporisation of the individual components of the individual portions of the liquid can be kept short and/or cycled with an energisation frequency in such a way that the step-by-step vaporisation cannot be perceived by a consumer and yet an extensively homogenous, flavour-conforming, repeatably precise formation of aerosol can be guaranteed. In particular, advantageously, vaporisation of a gently simmering component of the liquid initially takes place in a first vaporisation interval at a first temperature A and subsequently a vaporisation of a more vigorously simmering component of the liquid takes place in a second vaporisation interval at a second temperature B which is greater than the temperature A.

Preferably, a voltage curve Uh(t) which is matched to the liquid mixture used is stored in the data memory of the inhaler 27. This enables the voltage characteristic Uh(t) to be specified matched to the juice used, so that the heating temperature of the heating core 60, and therefore also the temperature of the capillary micro-channels 62, can be controlled in accordance with the known vaporisation kinetics of the particular juice with respect to time over the vaporisation process, as a result of which optimal vaporisation results can be achieved. The vaporisation temperature preferably lies in the range between 100° C. and 400° C., further preferably between 150° C. and 350° C., even further preferably between 190° C. and 290° C.

A porous and/or capillary, liquid-conducting wick structure, or that is to say the juice feed element 16, is arranged at the inlet side 61 of the heating core 60. The juice feed element 16 makes planar contact with the inlet side 61 of the heating core 60 and covers all micro-channels 62 on the inlet side as can be seen in FIG. 13. On the side opposite the heating core 60, the juice feed element 16 is connected to the liquid tank 30 in a liquid-conducting manner. The direct connection of the liquid tank 30 to the juice feed element 16 shown in FIGS. 12 and 13 is to be understood as only being an example. In particular, a liquid interface and/or one or more liquid ducts can be provided between liquid tank 30 and the juice feed element 16. Dimensionally, the liquid tank 30 can be larger than the juice feed element 16. For example, the juice feed element 16 can be fitted into a feed opening 45 of a housing 37 of the liquid tank 30. A plurality of vaporisers 3 can also be associated with one liquid tank 30.

The juice feed element 16 can be arranged in the base part 14 and/or the base plate 7 of the vaporiser insert 1. The juice feed element 16 can generally be in one piece or in several pieces.

The juice feed element 16 consists of porous and/or capillary material which, as a result of capillary forces, is able to passively convey an adequate amount of liquid vaporised by the heating core 60 from the liquid tank 30 to the heating core 60 in order to prevent the micro-channels 62 running empty and to avoid problems resulting therefrom.

Advantageously, the juice feed element 16 consists of a non-conducting material in order to prevent unwanted heating of liquid in the juice feed element 16 due to the flow of electrical current. If the juice feed element 16 consists of a conducting material, which is not excluded, an insulating layer of electrically and/or thermally insulating material, for example glass, ceramic or plastic, with through-openings corresponding to the micro-channels 62 extending through the insulating layer is advantageously provided between the juice feed element 16 and the heating core 60.

Advantageously, the juice feed element 16 consists of one or more of the following materials: cotton, cellulose, acetate, glass fibre mesh, glass fibre ceramic, sintered ceramic, ceramic paper, aluminosilicate paper, metal foam, metal sponge, other heat-resistant, porous and/or capillary material with suitable feed rate, or a composite of two or more of the above-mentioned materials. In an embodiment, the juice feed element 16 can be a classic wick. In an advantageous practical embodiment, the juice feed element 16 can comprise at least one ceramic fibre paper and/or a porous ceramic. The volume of the wick structure preferably lies in the range between 1 mm³ and 10 mm³, further preferably in the range between 2 mm³ and 8 mm³, even further preferably in the range between 3 mm³ and 7 mm³ and amounts, for example, to 5 mm³.

The heating core 60 can advantageously be produced using thin film layer technology from partial pieces of a wafer, which, preferably, has a film thickness of less than or equal to 1000 μm, further preferably less than or equal to 750 μm, even further preferably less than or equal to 500 μm. Surfaces of the heating core 60 can advantageously be hydrophilic. The inlet side 61 and/or the outlet side 64 of the heating core 60 can advantageously be micro-structured or have micro recesses (micro grooves).

The vaporiser insert 1 is designed such that a quantity of liquid preferably in the range between 1 μl and 20 μl, further preferably between 2 μl and 10 μl, even further preferably between 3 μl and 5 μl, typically 4 μl, is dosed for each draught by the consumer. Preferably, the vaporiser insert 1 can be adjustable with regard to the quantity of liquid/vapour per draught.

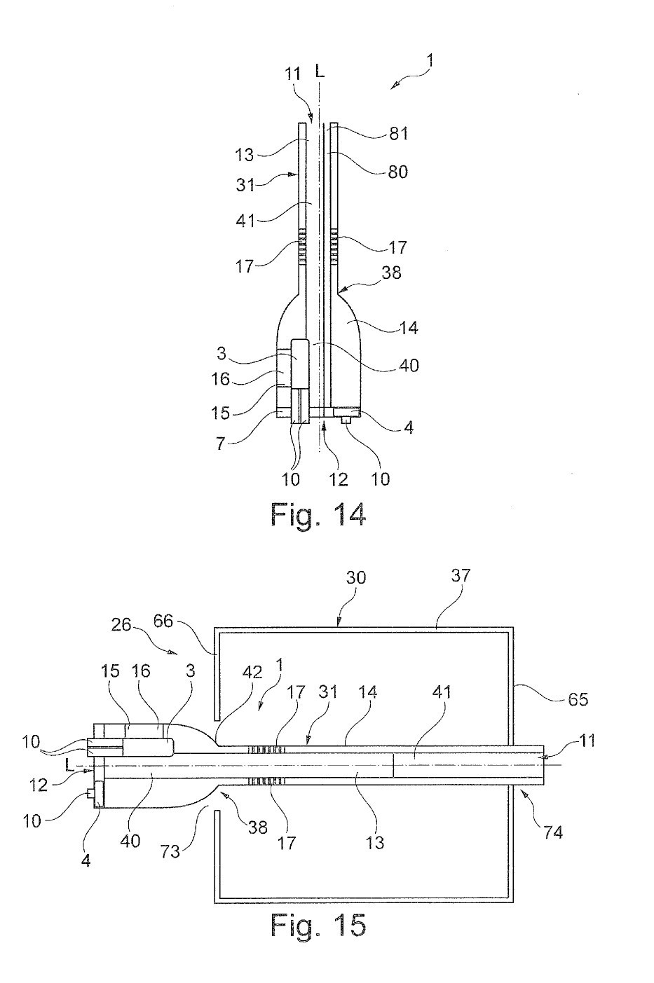

FIG. 14 shows a longitudinal section through an actuator insert 1 having a secondary air channel 80. The vaporiser insert 1 includes a separation wall 81, and the separation wall 80 separates the flow channel 13 from the secondary air channel 80. The separation wall 80 preferably runs section-by-section parallel to the longitudinal axis L of the vaporiser insert 1. The separation wall 81 can, for example, be tubular or hollow-cylindrical in shape and/or be connected to an inner wall of the base part 13. The separation wall 81 and/or the secondary air channel 80 advantageously extends through the whole vaporiser insert 1. Advantageously, a secondary airflow which can be guided through the secondary air channel 80 can be sensed by a vacuum sensor 46 provided in the inhaler 27.

FIG. 15 shows a vaporiser-tank unit 26 which is advantageous from the manufacturing point of view. In this embodiment, the vaporiser-tank unit 26 has a housing 37 with an insertion opening 42 and an outlet opening 74, but no inner wall 36 and no assembly channel 35.

In order to provide the vaporiser-tank unit 26, the vaporiser insert 1 is fed, in particular slid, with the outlet side face 11 to the outlet opening 74 so that the base part 14, or that is to say the jacket side 31, seals the outlet opening 74 to prevent leakage of liquid. The shape of the base part 14 gives rise to a filling opening 73 arranged between the base part 14 and the insertion opening 42. The liquid tank 30 can be filled with liquid, which is not shown in the diagram, via the filling opening 73. After filling the liquid tank 30, the vaporiser insert 1 is fed, in particular slid, through the insertion opening 42 as far as a stop so that the base part 14, or that is to say the jacket side 31, seals the insertion opening 42 to prevent leakage of liquid and thus provide a filled and leak-free vaporiser-tank unit 26.

In the assembled state of the vaporiser-tank unit 26, the vaporiser insert 2 extends through the insertion opening 42 to the outlet opening 74. In this example, the chimney 41 of the vaporiser insert 1 projects from the outlet opening 74. Preferably, the chimney 74 is supported in order to be flush with the face 65 of the housing 37, that is to say the liquid tank 30.

The filling for the liquid tank 30 described above is not obligatory. Alternatively, for example, the vaporiser-tank unit 26 can be ready-assembled and the tank 30 can be filled via an appropriate filling opening. Other types of filling are possible.

Embodiments

Embodiment 1. Vaporiser insert (1) for an inhaler (27) comprising
at least one electrical vaporiser (3) for vaporising liquid (2) fed to the vaporiser (3), and
electrical contacts (10) for making electrical contact with the vaporiser insert (1) for supplying with electrical energy and/or for receiving control signals for the vaporiser (3),
characterised in that
the vaporiser insert (1) has a base part (14) with opposingly arranged faces (11, 12) and a jacket side (31) between the faces arranged around at least one flow channel (13) through which vapour can flow, wherein
at least one liquid opening (15) for feeding vaporisable liquid (2) from the outside into the vaporiser insert (1) to the vaporiser (3) is arranged on the jacket side (31) of the base part (14).

Embodiment 2. Vaporiser insert (1) according to Embodiment 1, characterised in that
the in particular cartridge or jacket-shaped vaporiser insert (1) can be arranged in an external part, in particular in a liquid tank (30), in particular inserted or slid thereinto.

Embodiment 3. Vaporiser insert (1) according to Embodiment 2, characterised in that
the vaporiser insert (1) comprises at least one retaining and/or fixing element (38) for retaining and/or fixing the vaporiser insert (1) in the external part (30).

Embodiment 4. Vaporiser insert (1) according to Embodiment 2 or 3, characterised in that
the vaporiser insert (1) can be fitted in the external part (30) such that it cannot rotate.

Embodiment 5. Vaporiser insert (1) according to one of the preceding Embodiments, characterised in that
the electrical contacts (10) are arranged on one of the faces (11, 12) of the vaporiser insert (1).

Embodiment 6. Vaporiser insert (1) according to one of the preceding Embodiments, characterised in that
at least one permeable-to-air ventilation and/or venting device (17) is provided on the jacket side of the base part (14).

Embodiment 7. Vaporiser insert (1) according to one of the preceding Embodiments, characterised in that
the flow channel (13) comprises at least one pre and/or post-treatment area (18) for pre-treatment and/or post-treatment of air and/or vaporised liquid (2) flowing through the flow channel (13).

Embodiment 8. Vaporiser insert (1) according to one of the preceding Embodiments, characterised in that
the vaporiser insert (1) comprises a plurality of electrical vaporisers (3a, 3b).

Embodiment 9. Vaporiser insert (1) according to Embodiment 8, characterised in that
the electrical vaporisers (3a, 3b) are arranged along the periphery of the jacket side (31) of the base part (14) and/or along the flow channel (13).

Embodiment 10. Vaporiser insert (1) according to one of Embodiments 8 or 9, that
the vaporiser insert (1) has a plurality of liquid openings (15a, 15b), wherein
liquid (2a, 2b) from a corresponding liquid opening (15a, 15b) can be fed to each electrical vaporiser (3a, 3b).

Embodiment 11. Vaporiser insert (1) according to one of the preceding Embodiments, characterised in that
the vaporiser insert (1) has at least one retaining element, in particular a spur (32), on the jacket side (31) of the base part (14) for securing a capillary element (33) in a liquid tank (30).

Embodiment 12. Vaporiser insert (1) according to one of the preceding Embodiments, characterised in that
the vaporiser insert (1) comprises at least one secondary air channel (80) which is separate from the flow channel (13).

Embodiment 13. Vaporiser insert (1) according to one of the preceding Embodiments, characterised in that
the liquid opening (15) communicates with a juice feed element (16), wherein
the juice feed element (16) is designed to transport liquid (2) to the vaporiser (3).

Embodiment 14. Vaporiser insert (1) according to one of the preceding Embodiments, characterised in that
the vaporiser insert (1) comprises an electronic unit (4) for controlling and/or regulating the vaporiser (3) and/or for storing characteristic data.

Embodiment 15. Vaporiser insert (1) according to one of the preceding Embodiments, characterised in that the base part (14) is cartridge or sleeve-shaped.

Embodiment 16. Vaporiser-tank unit (26) comprising a liquid tank (30) and a vaporiser insert (1) according to one of the preceding Embodiments inserted in the liquid tank (30), characterised in that
the liquid tank (30) has an insertion opening (42) and an outlet opening (74), wherein
the vaporiser insert (1) extends from the insertion opening (42) to the outlet opening (74).

Embodiment 17. Vaporiser-tank unit (26) according to Embodiment 16, characterised in that
the liquid tank (30) encompasses the jacket side (31) of the vaporiser insert (1) at least in the section of the liquid opening (15).

Embodiment 18. Vaporiser-tank unit (26) according to one of Embodiments 16 or 17, characterised in that
a capillary element (33) inside the liquid tank (30) is associated with the liquid opening (15).

Embodiment 19. Vaporiser-tank unit (26) according to one of Embodiments 16 to 18, characterised in that
the vaporiser insert (1) is retained in the vaporiser-tank unit (26) so that it cannot rotate.

Embodiment 20. Vaporiser-tank unit (26) according to one of Embodiments 16 to 19, characterised in that
the liquid tank (30) comprises a plurality of chambers (30a, 30b) which are separate from one another, and
liquid (2a, 2b) from a corresponding chamber (30a, 30b) can be fed to each electrical vaporiser (3a, 3b).

Embodiment 21. Vaporiser-tank unit (26) according to one of Embodiments 16 to 20, characterised in that
at least one of the faces (11, 12) of the vaporiser insert (1) is flush with a corresponding face (65, 66) of the liquid tank (30).

Embodiment 22. Vaporiser-tank unit (26) according to one of Embodiments 16 to 21, characterised in that
the liquid tank (30) has at least one air-permeable ventilation and/or venting element (47).

Embodiment 23. Inhaler (27) comprising a vaporiser insert (1) according to one or more of Embodiments 1 to 15 and/or a vaporiser-tank unit (26) according to one or more of Embodiments 16 to 22, and an energy store (55) for the electrical supply of the at least one vaporiser (3).

Embodiment 24. Method for the production of a vaporiser-tank unit (26) according to one of Embodiments 16 to 22 and/or an inhaler (27) according to Embodiment 23 comprising the provision of a vaporiser insert (1) according to one of the preceding Embodiments and a liquid tank (30), characterised in that the vaporiser insert (1) is inserted, in particular slid, into the insertion opening (42) and as far as the outlet opening (74) of the liquid tank (30).

Embodiment 25. Method according to Embodiment 24, characterised in that
the vaporiser insert (1) is fed, in particular slid, with the outlet side face (11) as far as the outlet opening (74);
the liquid tank (30) is filled with liquid (2) via a filling opening (73) arranged or remaining between the base part (14) and the insertion opening (42); and
the vaporiser insert (1) is fed, in particular slid, through the insertion opening (42) as far as a stop, at the same time closing the filling opening (73).

Embodiment 26. Method according to one of Embodiments 24 or 25, characterised in that
the vaporiser insert (1) is produced as a module which can be or is fed to a production flow for a vaporiser-tank unit (26) and/or an inhaler (27).

1. A vaporiser insert for an inhaler, comprising:
at least one electrical vaporiser for vaporising liquid fed to the at least one electrical vaporiser;
electrical contacts for making electrical contact with the vaporiser insert for supplying the at least one electrical vaporizer with electrical energy and/or for receiving control signals for the at least one electrical vaporiser;
a base part with opposingly arranged faces and a jacket side between the opposingly arranged faces arranged around at least one flow channel through which vapour can flow; and
wherein at least one liquid opening for feeding vaporisable liquid from outside the vaporiser insert to the at least one electrical vaporiser is arranged on the jacket side of the base part.

2. The vaporiser insert according to claim 1,
wherein the vaporiser insert is configured to be inserted or slid into a liquid tank.

3. The vaporiser insert according to claim 2, further comprising:
at least one retaining and/or fixing element for retaining and/or fixing the vaporiser insert in the liquid tank.

4. The vaporiser insert according to claim 2,
wherein the vaporiser insert is configured such that, when inserted or slid into the liquid tank, the vaporizer insert cannot rotate with respect to the liquid tank.

5. The vaporiser insert according to claim 1,
wherein the electrical contacts are arranged on one of the opposingly arranged faces of the vaporiser insert.

6. The vaporiser insert according to claim 1,
wherein at least one permeable-to-air ventilation and/or venting device is provided on the jacket side of the base part.

7. The vaporiser insert according to claim 1,
wherein the flow channel comprises at least one pre-treatment and/or post-treatment area for pre-treatment and/or post-treatment of air and/or vaporised liquid flowing through the flow channel.

8. The vaporiser insert according to claim 1,
wherein the at least one electrical vaporiser is a plurality of electrical vaporisers.

9. The vaporiser insert according to claim 8,
wherein the plurality of electrical vaporisers are arranged along a periphery of the jacket side of the base part and/or along the flow channel.

10. The vaporiser insert according to claims 8,
wherein the vaporiser insert has a corresponding plurality of liquid openings; and
wherein liquid from a corresponding liquid opening of the plurality of liquid openings can be fed to each electrical vaporiser of the plurality of electrical vaporisers.

11. The vaporiser insert according to claim 8,
wherein the vaporiser insert has at least one retaining element on the jacket side of the base part for securing a capillary element in a liquid tank.

12. The vaporiser insert according to claim 1,
wherein the vaporiser insert comprises at least one secondary air channel which is separate from the flow channel.

13. The vaporiser insert according to claim 1,
wherein the at least one liquid opening communicates with a juice feed element, and
wherein the juice feed element is designed to transport liquid to the at least one electrical vaporiser.

14. The vaporiser insert according to claim 1,
wherein the vaporiser insert comprises an electronic unit to control and/or regulate the vaporiser and/or store characteristic data.

15. The vaporiser insert according to claim 1,
wherein the base part is cartridge or sleeve-shaped.

16. A vaporiser-tank unit, comprising:
a liquid tank; and
a vaporiser insert according to claim 1 inserted in the liquid tank,
wherein the liquid tank has an insertion opening and an outlet opening; and
wherein the vaporiser insert extends from the insertion opening to the outlet opening.

17. The vaporiser-tank unit according to claim 16,
wherein the liquid tank encompasses the jacket side of the vaporiser insert at least in a section of the at least one liquid opening.

18. The vaporiser-tank unit according to claim 16,
wherein a corresponding at least one capillary element inside the liquid tank is associated with the at least one liquid opening.

19. The vaporiser-tank unit according to claim 16,
wherein the vaporiser insert is retained in the liquid tank so that the vaporiser insert cannot rotate with respect to the liquid tank.

20. The vaporiser-tank unit according to claim 16,
wherein the liquid tank comprises a corresponding plurality of chambers which are separate from one another, and
wherein liquid from a corresponding chamber of the plurality of chambers can be fed to each electrical vaporiser of the plurality of electrical vaporisers.

21. The vaporiser-tank unit according to claim 16,
wherein at least one face of the opposingly arranged faces of the vaporiser insert is flush with a corresponding face of the liquid tank.

22. The vaporiser-tank unit according to claim 16,
wherein the liquid tank has at least one air-permeable ventilation and/or venting element.

23. An inhaler comprising:
a vaporiser insert according to claim 1; and
an energy store for supplying the electrical energy to the at least one electrical vaporiser.

24. A method for production of a vaporiser-tank unit, comprising:
providing a vaporiser insert according to claim 1 and a liquid tank,
wherein the liquid tank has an insertion opening and an outlet opening,
inserting the vaporiser insert into the insertion opening and as far as the outlet opening of the liquid tank.

25. The method according to claim 24,
wherein the vaporiser insert is inserted with an outlet side face of the opposingly arranged faces as far as the outlet opening;
wherein the liquid tank is filled with liquid via a filling opening arranged or remaining between the base part and the insertion opening; and
wherein the vaporiser insert is inserted through the insertion opening as far as a stop, at the same time closing the filling opening.

26. The method according to claim 24,
wherein the vaporiser insert is produced as a module which can be or is fed to a production flow for the vaporiser-tank unit and/or an inhaler.
